(19) United States
(12) Patent Application Publication
(10) Pub. No.: US 2008/0313674 A1
(43) Pub. Date: Dec. 18, 2008

(54) USER INTERFACE FOR FAST CHANNEL BROWSING

(76) Inventors: Randy R. Dunton, Phoenix, AZ (US); Wesley A. Macdonald, Gilbert, AZ (US)

Correspondence Address: INTEL CORPORATION;c/o INTELLEVATE, LLC, P.O. BOX 52050, MINNEAPOLIS, MN, 55402, US

(21) Appl. No.: 11/761,881

(22) Filed: Jun. 12, 2007

(51) Int. Cl. G06F 3/00

(52) U.S. Cl. 725/43

(57) ABSTRACT

A user interface with software tensing may be described. An apparatus may include a user interface module to display a channel lineup representing what is currently being offered by one or more channels. Each of the channels has one or more identifiers including at least a visual data identifier. The user interface module receives basic visual data for each of the channels from a first dedicated tuner. A media lensing module to increase a size of the visual data identifier of a channel of interest in the channel lineup when a pointer coincides with the channel of interest. The user interface module to receive detailed visual data from a second dedicated tuner for the channel of interest. The user interface module to replace the basic visual data of the visual data identifier for the channel of interest with the detailed visual data. Other embodiments are described and claimed.

### RELATED APPLICATIONS

This application is a related to a commonly owned U.S. patent application Ser. No. 11/323,088 titled “A User Interface For A Media Device” and filed on Dec. 30, 2005; a commonly owned U.S. patent application Ser. No. 11/322,937 titled “Techniques For Generating Information Using A Remote Control” and filed on Dec. 30, 2005; a commonly owned U.S. patent application Ser. No. 11/322,580 titled “A User Interface with Software Lensing” and filed on Dec. 30, 2005; a commonly owned U.S. patent application Ser. No. ______ titled “A User Interface with Software Lensing for Very Long Lists of Content” and filed on Jun. 12, 2007; and a commonly owned U.S. patent application Ser. No. ______ titled “Channel Lineup Reorganization Based on Metadata” and filed on Jun. 12, 2007, all of which are incorporated herein by reference.

### BACKGROUND

Consumer electronics and processing systems are converging. Consumer electronics such as televisions and media centers are evolving to include processing capabilities typically found on a computer. The increase in processing capabilities may allow consumer electronics to execute more sophisticated system and application programs. Such programs typically require robust user interfaces, capable of displaying arid navigating through ever increasing amounts of information. Accordingly, there may be a need for improved techniques to solve these and other problems.

### BRIEF DESCRIPTION OF THE DRAWINGS

FIG. 1 illustrates one embodiment of an environment.

FIG. 2 illustrates one embodiment of a user interface display.

FIG. 3 illustrates one embodiment of a logic flow.

FIG. 4 illustrates one embodiment of a media processing system.

### DETAILED DESCRIPTION

Various embodiments may be directed to a user interface utilizing various software lensing techniques for fast channel browsing or surfing of content. The software lensing techniques may be used for various applications. For example, the software lensing techniques may be used to navigate through a channel lineup (e.g., a vertical list of channels) represented via progressive still images to running video to aid a user in the selection of a channel in such a way that the user is not required to “page through”, “tab” or “scroll through” the options. Other embodiments are described and claimed.

Today's digital home environment provides the opportunity for hundreds of television channels. Each channel may represent an analog broadcast channel; a digital broadcast channel; audio-video data pre-recorded and stored on a digital recording device; audio-video data available for streaming, downloading or accessing via the Internet (e.g., Web site); audio-video data stored on a home local area network (LAN); and so forth.

Since there may be hundreds of potential channels available, it may be particularly burdensome for a user to browse through the channels via a traditional “TV guide” type grid. To increase the amount of viewing information, embodiments of the invention provide for a fast browsing mode user interface. The fast browsing mode user interface includes a channel lineup displayed in a vertical format. Each channel in the lineup is associated with various identifiers that provide information about what is currently being offered by the particular channel. Such identifiers may include, but are not limited to, channel name (e.g., NBC, ABC, HGTV); channel number; metadata associated with the content currently being offered by the channel (e.g., title of content or program, content description, year of release, ratings information, category, stars, a brief synopsis, etc.); a thumbprint of the channel logo; a thumbprint of visual data showing what is currently being offered by the channel; audio related to the visual data; and so forth. In general, a thumbprint is a bitmap or graphic texture. These examples are not meant to limit the invention.

In embodiments, one or more dedicated tuners may be used to scan all of the channels in the lineup on a periodic basis and to render basic visual data for each channel. The basic visual data is cached and displayed as a still image in a thumbprint for its associated channel in the lineup. The still image helps to quickly inform the user what the particular channel is currently playing, as well as the neighboring channels, at one glance.

The direction in which the user is browsing through the channel lineup is determined. Based on the determined direction and the current position of a cursor or pointer on the channel lineup, the next likely channels to be browsed by the user are determined. One or more dedicated tuners are used to scan ahead and render more detailed visual data for these channels. When the user spends an amount of time on a particular channel, the still image shown in the thumbprint starts to display live video. With more time, the thumbprint may begin to slowly occupy a larger part of a display screen and associated audio may start to play. The embodiments are not limited in this context.

Various embodiments may use software lensing techniques to increase a size for the identifiers of a channel when the cursor or pointer approaches or coincides with the channel in the lineup.

Various embodiments may include a fast browsing mode user interface arranged to accept user input from a remote control. For example, the user interface module may be arranged to receive movement information representing pointing movements of the remote control. The remote control may be arranged to provide movement information as a user moves the remote control through space, such as moving the remote control to point to different objects displayed on a screen. In this manner, a user may enter information into a media device such as a television or set top box using the remote control as an “air” mouse or free-form pointing device. Alternatively, a user may provide movement information to the user interface module using other pointing devices implemented as either separate from the remote control or integrated with the remote control. The embodiments are not limited in this context.

Various embodiments may comprise one or more elements or components. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

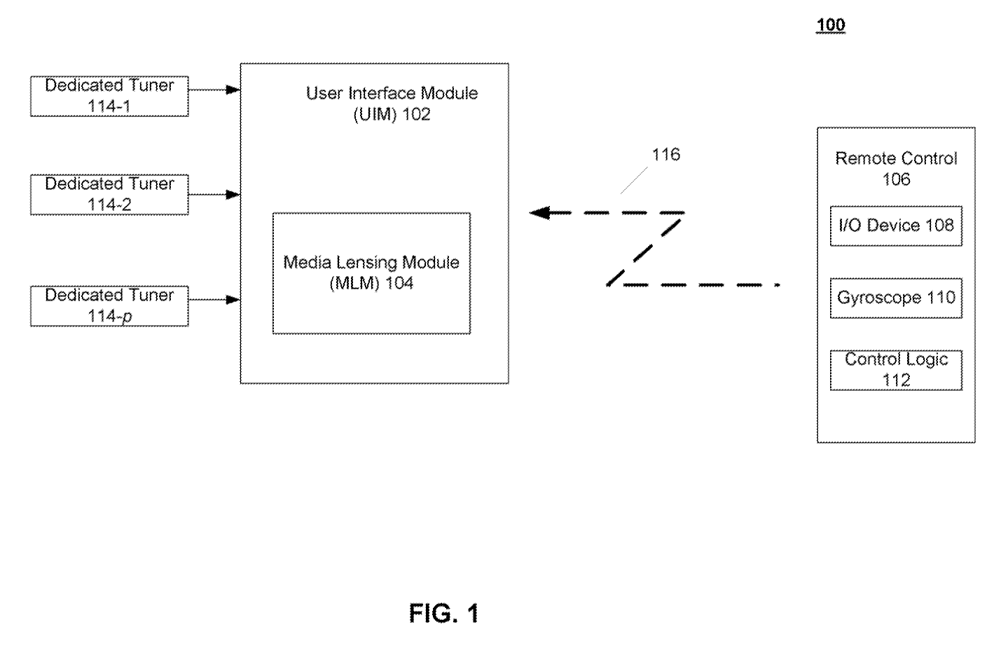

FIG. 1 illustrates one embodiment of an environment in which embodiments of the invention may operate. Referring to FIG. 1, the environment may include a user interface module (UIM) 102, a remote control 106 and dedicated tuners 114-1-p. UIM 102 may include a media lensing module (MLM) 104. Remote control 106 may include an input/output (I/O) device 108, a gyroscope 110 and control logic 112. Each of these elements is described next in more detail.

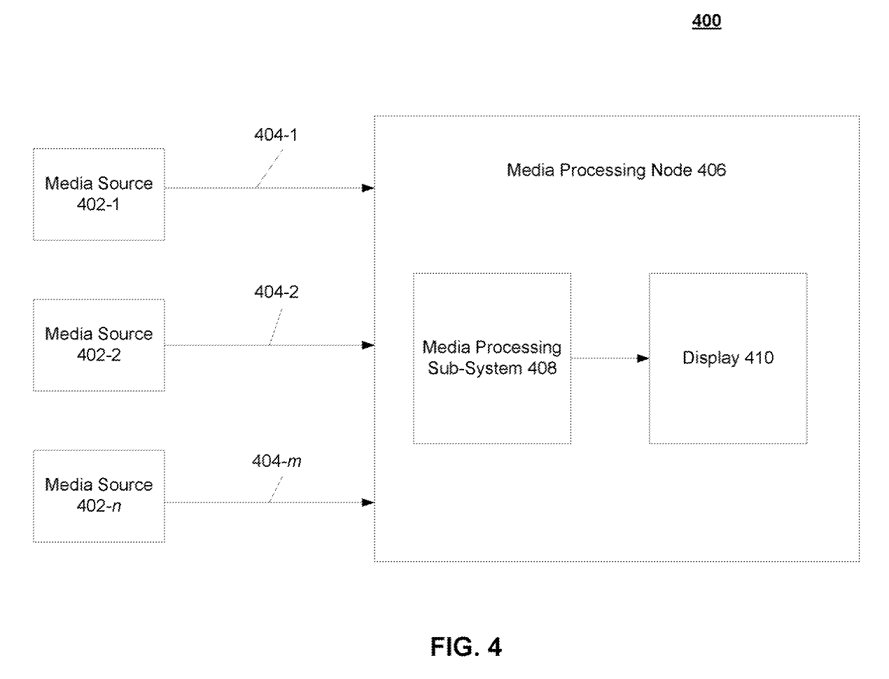

In one embodiment, for example, a media processing sub-system may include various application programs, such as UIM 102. For example, UIM 102 may comprise a graphic user interface (GUI) to communicate information between a user and the media processing sub-system. UIM 102 may be used to navigate through large amounts of available channels, for example, via a networked digital home environment. An example media processing sub-system will be described in detail below with reference to FIG. 4.

In various embodiments, UIM 102 may include MLM 104. Alternatively, MLM 104 may be a separate component from UIM 102. MLM 104 may include the appropriate interfaces (e.g., API) to communicate information with UIM 102. MLM 104 may implement different software lensing techniques to increase, enlarge or magnify a size for identifiers associated with an information object or channel on a display when the pointer coincides with the channel, or the pointer is within a predefined distance from the channel. As mentioned above, identifiers may include channel name (e.g., NBC, ABC, HGTV); channel number; metadata associated with the content currently being offered by the channel (e.g., title of content or program, content description, year of release, ratings information, category, stars, a brief synopsis, etc.); a thumbprint of the channel logo; a thumbprint of visual data showing what is currently being offered by the channel; audio related to the visual data; and so forth. These examples are not meant to limit the invention.

In various embodiments, UIM 102 may be arranged to receive input via one or more dedicated timers 114-1-p. Some of the dedicated tuners may be used to scan all of the channels in the lineup on a periodic basis and to render basic visual data for each channel. As mentioned above, the basic visual data is cached and displayed as a still image in a thumbprint for its associated channel in the lineup. The still image helps to quickly inform the user what the particular channel is currently playing, as well as the neighboring channels, at one glance.

Other of the dedicated tuners may be used to scan ahead and render more detailed visual data for these channels. When the user spends an amount of time on a particular channel, a still image shown in the thumbprint of visual data starts to display live video. In embodiment, associated audio may also be played. The detailed visual data is used to display the live video.

In various embodiments, UIM 102 may be arranged to receive user input via remote control 106. Remote control 106 may be arranged to allow a user to perform pointing operations similar to a mouse or other pointing device using gyroscope 110. UIM 102 and remote control 106 allow a user to control a pointer on a display even when situated a relatively far distance from the display, such as normal viewing distance (e.g., 10 feet or more), and without the need for typical wired connections.

Remote control 106 may be arranged to control, manage or operate the media processing sub-system of UIM 102 by communicating control information using infrared (IR) or radio-frequency (RF) signals. In one embodiment, for example, remote control 106 may include one or more light-emitting diodes (LED) to generate the infrared signals. The carrier frequency and data rate of such infrared signals may vary according to a given implementation. An infrared remote control may typically send the control information in a low-speed burst, typically for distances of approximately 30 feet or more. In another embodiment, for example, remote control 106 may include an RF transceiver. The RF transceiver may match the RF transceiver used by the media processing sub-system. An RF remote control typically has a greater distance than an IR remote control, and may also have the added benefits of greater bandwidth and removing the need for line-of-sight operations. For example, an RF remote control may be used to access devices behind objects such as cabinet doors.

The control information may include one or more IR or RF remote control command codes (“command codes”) corresponding to various operations that the device is capable of performing. The command codes may be assigned to one or more keys or buttons included with I/O device 108 for remote control 106. I/O device 108 may comprise various hardware or software buttons, switches, controls or toggles to accept user commands. For example, I/O device 108 may include a numeric keypad, arrow burtons, selection buttons, power buttons, mode buttons, selection buttons, menu buttons, and other controls needed to perform the normal control operations typically found in conventional remote controls. There are many different types of coding systems and command codes, and generally different manufacturers may use different command codes for controlling a given device.

In addition to I/O device 108, remote control 106 may also include elements that allow a user to enter information into a user interface at a distance by moving the remote control through the air in two or three dimensional space. For example, remote control 106 may include gyroscope 110 and control logic 112. Gyroscope 110 may comprise a gyroscope typically used for pointing devices, remote controls and game controllers. For example, gyroscope 110 may comprise a miniature optical spin gyroscope. Gyroscope 110 may be an inertial sensor arranged to detect natural hand motions to move a cursor or graphic on a display, such as a television screen or computer monitor. Gyroscope 110 and control logic 112 may be components for an “In Air” motion-sensing technology that can measure the angle and speed of deviation to move a cursor or other indicator between Point A and Point B, allowing users to select content or enable features on a device waving or pointing remote control 106 in the air. In this arrangement, remote control 106 may be used for various applications, to include providing device control, content indexing, computer pointers, game controllers, content navigation and distribution to fixed and mobile components through a single, hand-held user interface device.

Although some embodiments are described with remote control 106 using a gyroscope 110 by way of example, it may be appreciated that other free-space pointing devices may also be used with remote control 106 or in lieu of remote control 106. For example, some embodiments may use a free-space pointing device made by Hillcrest Labs™ for use with the Welcome HoME™ system, a media center remote control such as WavIt MC™ made by ThinkOptics, Inc., a game controller such as WavIt XT™ made by ThinkOptics, Inc., a business presenter such as WavIt XB™ made by ThinkOptics, Inc., free-space pointing devices using aceelerometers, and so forth. The embodiments are not limited in this context.

In one embodiment, for example, gyroscope 110 and control logic 112 may be implemented using the MG1101 and accompanying software and controllers as made by Thomson's Gyration, Inc., Saratoga, Calif. The MG1101 is a dual-axis miniature rate gyroscope that is self-contained for integration into human input devices such as remote control 106. The MG1101 has a tri-axial vibratory structure that isolates the vibrating elements to decrease potential drift and improve shock resistance. The MG1101 can be mounted directly to a printed circuit board without additional shock mounting. The MG1101 uses an electromagnetic transducer design and a single etched beam structure that utilizes the “Coriolis Effect” to sense rotation in two axes simultaneously. The MG1101 includes an integrated analog-to-digital converter (ADC) and communicates via a conventional 2-wire serial interface bus allowing the MG1101 to connect directly to a microcontroller with no additional hardware. The MG1101 further includes memory, such as 1K of available EEPROM storage on board, for example. Although the MG1101 is provided by way of example, other gyroscope technology may be implemented for gyroscope 110 and control logic 112 as desired for a given implementation. The embodiments are not limited in this context.

In operation, a user may use remote control 106 to provide information for the user interface module 102 at a distance by moving remote control 106 through the air, similar to an air mouse. For example, a user may point remote control 106 to various objects displayed on the display. Gyroscope 110 may sense the movements of remote control 106, and send movement information representing the movements to a media processing node over wireless communications media 116. UIM 102 may receive the movement information, and move a pointer (e.g., mouse pointer) or cursor in accordance with the movement information on the display. UIM 102 may use the movement information and associated selection commands to perform any number of user defined operations for a networked digital home network, such as navigating option menus, selecting options, searching for media content, selecting media objects, and so forth.

In addition to operating as an air mouse or pointing device using gyroscope 110 and control logic 112, remote control 106 may use other techniques to control a pointer. For example, remote control 106 may include an integrated pointing device. The pointing device may include various types of pointer controls, such as a track or roller ball, a pointing stick or nub, a joystick, arrow keys, direction keys, and so forth. Integrating a pointing device with remote control 106 may facilitate pointing operations for a user. Alternatively, a user may use a pointing device separate from remote control 106, such as various different types of mice or controllers. The pointing device may also be part of another device other than remote control 106, such as a wired or wireless keyboard. The particular implementation for the pointing device may vary as long as the pointing device provides movement information for the user interface module and allows a user to generate the movement information from a distance (e.g., normal viewing distance). The embodiments are not limited in this context.

As discussed above, the networked digital home environment of today provides a user with many channels from which to choose. Typical electronic programming guide X/Y grids are too limiting. Embodiments of the invention provide for a way to allow the user to navigate and select from a channel lineup without “paging through”, “tabbing” or “scrolling through” the channels.

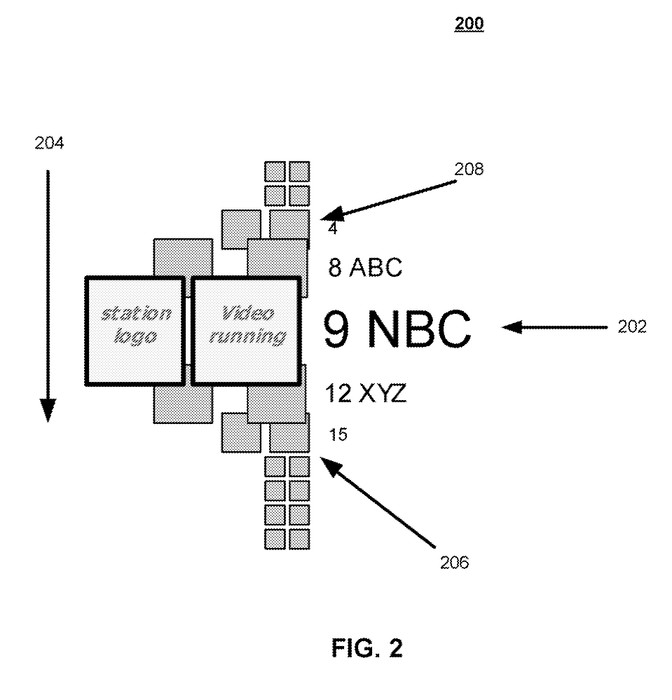

FIG. 2 illustrates one embodiment of a fast browsing mode user interface display 200. User interface display 200 may provide an example of a GUI display generated by UIM 102. As shown in FIG. 2, user interface display 200 may display a channel lineup in a vertical, stacked or list format. Each channel in user interface display 200 has associated identifiers. In the embodiment illustrated in FIG. 2, such identifiers include (from right to left) a channel name, a channel number, a thumbprint of visual data and a thumbprint of the channel logo. For example, a cursor 202 is currently position over a channel with “NBC” as the channel name and “9” as the channel number. The exemplary identifiers illustrated in FIG. 2 are not meant to limit the invention. Other exemplary identifiers may include metadata associated with the content currently being offered by the channel (e.g., title of content or program, content description, year of release, ratings information, category, stars, a brief synopsis, etc.). These examples are not meant to limit the invention.

Cursor 202 represents the current position of the user in the channel lineup. Arrow 208 illustrates channels that have thumbprints of visual data with still images. Here, data for the still images has been cached earlier via one or more dedicated tuners 114-1-p. Arrow 204 illustrates the direction a user is browsing through the channel lineup. Arrow 206 illustrates the next likely channels to be browsed by the user. One or more dedicated tuners 114-1-p is used to scan ahead and render more detailed visual data for these channels. When the user spends an amount of time on a particular channel in the lineup (i.e., the cursor is positioned over the particular channel for a period of time), a still image shown in the thumbprint of visual data starts to display live video and possible associated audio.

As shown in FIG. 2, the channel lineup may comprise multiple channels represented in a vertical, stacked or list format. In general, UIM 102 may display a greater number of channels (and its associated identifiers) as the size of each individual channel is decreased, and vice-versa. For example, the channels of the lineup as shown in user interface display 200 may be relatively small. In some cases, for example, the channels have a font size and thumbprint size that is beyond the visual range of many viewers. The channel lineup may display a relative large number of channels due in part to the smaller font and thumbprint size.

As cursor or pointer 202 approaches or coincides with a channel in the lineup, MLM 104 may increase the font size for applicable identifiers (e.g., channel name and number) and may increase the graphic size for applicable thumbprints (e.g., channel logo and visual data thumbprints) thereby making the identifiers large enough for viewing by a user in a real time fashion, just as if a magnifying glass were attached to cursor 202 (e.g., software lensing). MLM 104 may also increase the font and/or graphic size for identifiers within a predefined area around the channel of interest, such as adjacent to or near the channel under cursor 202. This may allow a user to read identifiers for some of the channels within a certain predefined area around the channel of interest. The size of the surrounding channels, however, is typically smaller than the size of the channel of interest, thereby allowing a user to more readily discern the channel of interest. Color may be used as well to provide visual unambiguous feedback to the user which channel is currently the channel of interest. In this manner, user interface display 200 may convey a relatively larger amount of information (e.g., channels) to a viewer via a display, but only the area of interest plus any surrounding areas is large enough to be read by a viewer as controlled by the viewer via remote control 106. This may be accomplished while reducing the need for scrolling, paging or indexing operations as implemented by conventional user interfaces.

It may be appreciated that the various elements of user interface display 200 are provided by way of example only, and more or less elements in different arrangements may be used by UIM 102 and still fall within the intended scope of the embodiments. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

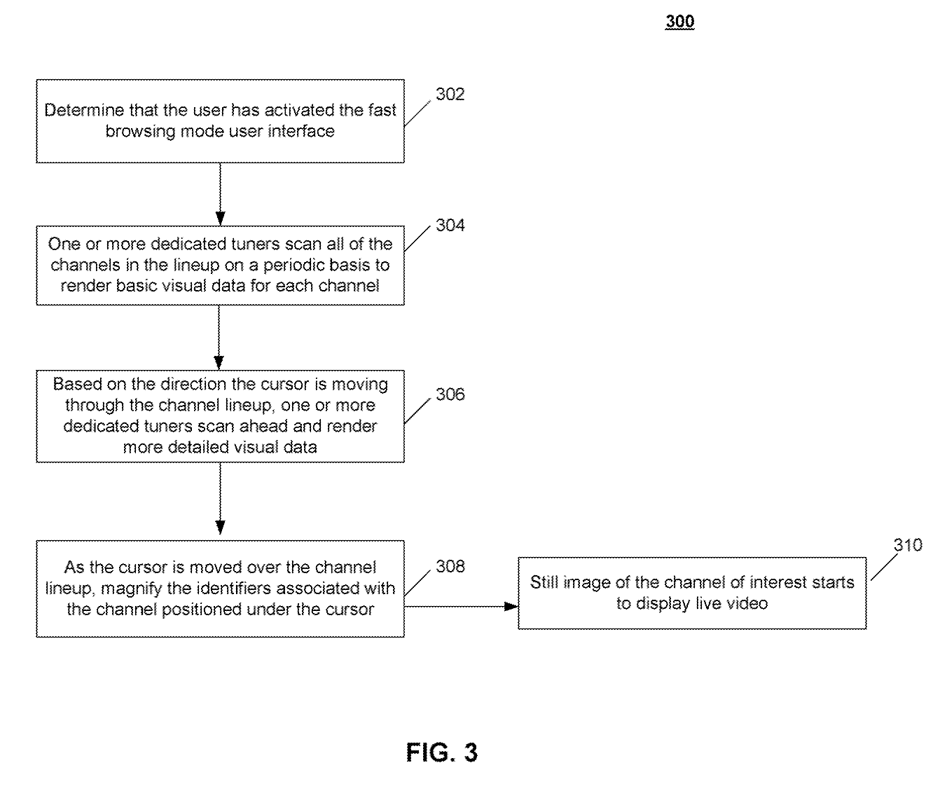

FIG. 3 illustrates one embodiment of a logic flow 300. Logic flow 300 may be representative of the operations executed by one or more embodiments described herein, such as UIM 102, and/or MLM 104. Referring to FIG. 3, it is determined that a user has activated the fast browsing mode user interface (block 302). One or more dedicated tuners scan all of the channels in the lineup on a periodic basis to render basic visual data for each channel (block 304). In embodiments, the basic visual data is used for the still images of the thumbprints. Based on the direction the cursor is moving through the channel lineup, one or more dedicated tuners scan ahead and render more detailed visual data (block 306). In embodiments, the more detailed visual data is used for the live video of the thumbprint for the channel positioned under the cursor. As the cursor is moved over the channel lineup, the identifiers associated with the channel positioned under the cursor are magnified (block 308). The still image of the thumbprint of the channel of interest (positioned under the cursor) starts to display live video (block 310).

FIG. 4 illustrates one embodiment of a media processing system in which some embodiments of the invention may operate. FIG. 4 illustrates a block diagram of a media processing system 400. In one embodiment, system 400 may represent a networked digital home environment, although system 400 is not limited in this context.

In one embodiment, for example, media processing system 400 may include multiple nodes. A node may comprise any physical or logical entity for processing and/or communicating information in the system 400 and may be implemented as hardware, software, or any combination thereof, as desired for a given set of design parameters or performance constraints. Although FIG. 4 is shown with a limited number of nodes in a certain topology, it may be appreciated that system 400 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a television, a digital television, a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. The embodiments are not limited in this context.

In various embodiments, media processing system 400 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television Systems Committee (NTSC) standard, the Advanced Television Systems Committee (ATSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the DVB Satellite (DVB-S) broadcasting standard, the DVB Cable (DVB-C) broadcasting standard, the Open Cable standard, the Society of Motion Picture and Television Engineers (SMPTE) Video-Codec (VC-1) standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of media processing system 400 may be arranged to communicate, manage or process different types of information, such as media information and control information. Examples of media information may generally include any data or signals representing content meant for a user, such as media content, voice information, video information, audio information, image information, textual information, numerical information, alphanumeric symbols, graphics, and so forth. Control information may refer to any data or signals representing commands. instructions or control words meant for an automated system. For example, control information may be used to route media information through a system, to establish a connection between devices, instruct a node to process the media information in a predetermined manner, monitor or communicate status, perform synchronization, and so forth. The embodiments are not limited in this context.

In various embodiments, media processing system 400 may be implemented as a wired communication system, a wireless communication system, or a combination of both. Although media processing system 400 may be illustrated using a particular communications media by way of example, it may be appreciated that the principles and techniques discussed herein may be implemented using any type of communication media and accompanying technology. The embodiments are not limited in this context.

In various embodiments, media processing system 400 may include one or more media source nodes 402-1-n. Media source nodes 402-1-n may comprise any media source capable of sourcing or delivering media information and/or control information to media processing node 406. More particularly, media source nodes 402-1-n may comprise any media source capable of sourcing or delivering digital audio and/or video (AV) signals to media processing node 406. Examples of media source nodes 402-1-n may include any hardware or software element capable of storing and/or delivering media information, such as a DVD device, a VHS device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, television system, digital television system, set top boxes, personal video records, server systems, computer systems, personal computer systems, digital audio devices (e.g., MP3 players), and so forth. Other examples of media source nodes 402-1-n may include media distribution systems to provide broadcast or streaming analog or digital AV signals to media processing node 406. Examples of media distribution systems may include, for example, Over The Air (OTA) broadcast systems, terrestrial cable systems (CATV), satellite broadcast systems, and so forth. It is worthy to note that media source nodes 402-1-n may be internal or external to media processing node 406, depending upon a given implementation. The embodiments are not limited in this context.

In various embodiments, media processing system 400 may comprise a media processing node 406 to connect to media source nodes 402-1-n over one or more communications media 404-1-m. Media processing node 406 may comprise any node that is arranged to process media information received from media source nodes 402-1-n.

In various embodiments, media processing node 406 may include a media processing sub-system 408. Media processing sub-system 408 may comprise a processor, memory, and application hardware and/or software arranged to process media information received from media source nodes 402-1-n. For example, media processing sub-system 408 may be arranged to perform various media operations and user interface operations as described in more detail below. Media processing sub-system 408 may output the processed media information to a display 410. The embodiments are not limited in this context.

To facilitate operations, media processing sub-system 408 may include a user interface module and a media lensing module (such as UIM 102 and MLM 104 of FIG. 1) to provide software lensing and remote user input. Software lensing may refer to techniques for increasing, enlarging, or magnifying an area when a pointer or cursor coincides or approaches the area. This may be accomplished in real time with reduced delay, rather than by selection or loitering over a given area for a certain amount of time as in conventional techniques. Although software lensing is typically implemented in software, it may be appreciated that all or portions of the software lensing technique may be performed by software, hardware, or a combination of both. The embodiments are not limited in this context.

In various embodiments, the user interface module may allow a user to control certain operations of media processing node 406, such as various system programs or application programs. For example, assume media processing node 406 comprises a television that has access to user menu options provided via media source node 402-1-n. These menu options may be provided for viewing or listening to media content reproduced or provided by media source node 402-1-n. The user interface module may display user options to a viewer on display 410 in the form of a graphic user interface (GUI), for example. In such cases, a remote control (such as remote control 106 of FIG. 1) is typically used to navigate through such basic options.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. If can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable, logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, lava, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a user interface module to display a channel lineup representing what is currently being offered by one or more channels, wherein each of the channels having one or more identifiers including at least a visual data identifier, wherein the user interface module to receive basic visual data for each of the channels from a first dedicated tuner; and
a media lensing module to increase a size of the visual data identifier of a channel of interest in the channel lineup when a pointer coincides with the channel of interest,
wherein the user interface module to receive detailed visual data from a second dedicated tuner for the channel of interest and wherein the user interface module to replace the basic visual data of the visual data identifier for the channel of interest with the detailed visual data.

2. The apparatus of claim 1, wherein the basic visual data to represent a still image and the detailed visual data to present live video.

3. The apparatus of claim 2, wherein the visual data identifier is a thumbprint.

4. The apparatus of claim 1, wherein the one or more identifiers to further include at least one of a channel name, a channel number and a channel logo.

5. The apparatus of claim 1, wherein the channel lineup is displayed in a vertical format.

6. The apparatus of claim 1, wherein the user interface module to receive movement information from a remote control, and move the pointer in response to the movement information, wherein the remote control is a free-form pointing device.

7. The apparatus of claim 1, wherein the one or more identifiers to further include at least one of a channel name, a channel number and a channel logo and wherein the media lensing module to increase a size of the one or more identifiers of the channel of interest and neighboring channels to the channel of interest in the channel lineup when a pointer coincides with the channel of interest.

8. A method, comprising:
displaying a channel lineup representing what is currently being offered by one or more channels, wherein each of the channels having one or more identifiers including at least a visual data identifier;
receiving basic visual data for each of the channels from a first dedicated tuner;
increasing a size of the visual data identifier of a channel of interest in the channel lineup when a pointer coincides with the channel of interest;
receiving detailed visual data from a second dedicated tuner for the channel of interest; and
replacing the basic visual data of the visual data identifier for the channel of interest with the detailed visual data.

9. The method of claim 8, wherein the basic visual data to represent a still image and the detailed visual data to present live video.

10. The method of claim 9, wherein the visual data identifier is a thumbprint.

11. The method of claim 8, wherein the one or more identifiers to further include at least one of a channel name, a channel number and a channel logo.

12. The method of claim 8, wherein the channel lineup is displayed in a vertical format.

13. The method of claim 8, further comprising:
receiving movement information from a remote control; and
moving the pointer in response to the movement information,
wherein the remote control is a free-form pointing device.

14. The method of claim 8, further comprising:
increasing a size of the one or more identifiers of the channel of interest and neighboring channels to the channel of interest in the channel lineup when a pointer coincides with the channel of interest,
wherein the one or more identifiers to further include at least one of a channel name, a channel number and a channel logo.

15. A machine-readable medium containing instructions which, when executed by a processing system, cause the processing system to perform a method, the method comprising;
displaying a channel lineup representing what is currently being offered by one or more channels, wherein each of the channels having one or more identifiers including at least a visual data identifier;
receiving basic visual data for each of the channels from a first dedicated tuner;
increasing a size of the visual data identifier of a channel of interest in the channel lineup when a pointer coincides with the channel of interest;
receiving detailed visual data from a second dedicated tuner for the channel of interest; and
replacing the basic visual data of the visual data identifier for the channel of interest with the detailed visual data.

16. The machine-readable medium of claim 15, wherein the basic visual data to represent a still image and the detailed visual data to present live video.

17. The machine-readable medium of claim 16, wherein the visual data identifier is a thumbprint.

18. The machine-readable medium of claim 15, wherein the one or more identifiers to further include at least one of a channel name, a channel number and a channel logo.

19. The machine-readable medium of claim 15, wherein the channel lineup is displayed in a vertical format.

20. The machine-readable medium of claim 8, further comprising:
increasing a size of the one or more identifiers of the channel of interest and neighboring channels to the channel of interest in the channel lineup when a pointer coincides with the channel of interest,
wherein the one or more identifiers to further include at least one of a channel name, a channel number and a channel logo.
